(19) United States
(12) Patent Application Publication
(10) Pub. No.: US 2026/0297461 A1
(43) Pub. Date: Oct. 1, 2026

(54) ENGINE COMBUSTION CHAMBER CLEANING SOLUTION COMPOSITION AND CLEANING METHOD USING THE SAME

(71) Applicant: KD Finechem Co., Ltd., Busan (KR)

(72) Inventors: Jae Yoon PARK, Seoul (KR); Hyun Jin PARK, Gyeonggi-do (KR); Hong Ki LEE, Busan (KR); Ji Yun HUH, Busan (KR)

(21) Appl. No.: 19/489,829

(22) PCT Filed: Nov. 6, 2023
(86) PCT No.: PCT/KR2023/017629

§ 371 Date: Dec. 3, 2025

(30) Foreign Application Priority Data
Jun. 26, 2023 (KR) 10-2023-0082123

(51) Int. Cl. C11D 3/33; C11D 1/14; C11D 1/722; C11D 1/90; C11D 3/04; C11D 3/08; C11D 3/10; C11D 3/18; C11D 3/43

(52) U.S. Cl. CPC C11D 3/33; C11D 1/146; C11D 1/722; C11D 1/90; C11D 3/042; C11D 3/08; C11D 3/10; C11D 3/188; C11D 3/43; C11D 2111/20; C11D 2111/44

(57) ABSTRACT

The present invention relates to a cleaning solution composition for an engine combustion chamber and a cleaning method using the same, and more specifically, the cleaning solution composition for an engine combustion chamber according to the present invention has excellent storage stability and can effectively remove carbon deposits fixed inside a cylinder of an engine, and the cleaning method for an engine combustion chamber according to the present invention does not disassemble an engine and can effectively remove carbon deposits fixed inside a cylinder of an engine by performing cleaning.

### TECHNICAL FIELD

This application claims priority to and the benefit of Korean Patent Application No. 10-2023-0082123 filed in the Korean Intellectual Property Office on 26 Jun. 2023, the disclosure of which is incorporated herein by reference.

The present invention relates to a cleaning solution composition for an engine combustion chamber and a cleaning method using the same.

### BACKGROUND ART

In the case of an internal combustion engine represented by an automobile, gas is generated from the engine exhaust gas as fuel is oxidized in the combustion chamber, and the gas generated during engine operation is a high-temperature acidic material that deteriorates and oxidizes the engine oil to contaminate the engine oil, and the contaminated oil gas enters the combustion chamber again. In this process, contaminated sediments such as sludge and carbon are generated inside the cylinder.

In particular, a hole, which is a small passage of the engine oil, is present in an oil ring groove on a side surface of the piston inside the engine, and when this portion is blocked by carbon sediment, etc., the engine oil remains in the combustion chamber when the piston descends and is converted into carbon, thereby continuously accumulating carbon in the combustion chamber. Carbon is soot generated during the combustion process of fuel, and when contaminated sediments such as carbon are accumulated inside the engine, engine efficiency decreases due to an increase in internal frictional resistance of the engine, knocking occurs, ride comfort becomes unstable due to vibration, and environmental pollution occurs due to excessive discharge of incomplete combustion materials.

Accordingly, in order to remove contaminated sediments such as carbon accumulated in an internal combustion engine, a method of simultaneously performing cleaning during combustion of fuel by mixing various additives with engine oil in the form of an engine oil cleaning solution or mixing a cleaning agent in the form of a fuel additive with fuel has been proposed.

Meanwhile, Korean Patent No. 10-1522330 discloses a method for preparing a cleaning solution for cleaning an engine by mixing dilimonene and a surfactant, and a cleaning solution composition.

However, in the case of the above technologies, cleaning is simultaneously performed during engine combustion, so that contaminated deposits cannot be effectively removed, or they are used as methods in which, before replacing engine oil, the cleaning solution is injected in a preheated state and the engine oil is discharged after idling for about 10 to 20 minutes for maintenance purposes, and methods in which the engine is disassembled and cleaned during vehicle maintenance, thereby having a problem of reduced cleaning efficiency.

In addition, in the case of a general fuel additive, the cleaning range is limited to the upper portion of the piston, and thus there is a limitation in that the carbon deposits in the oil ring of the side portion of the piston cannot be removed.

### DISCLOSURE OF INVENTION

### Technical Problem

An object of the present invention is to provide a cleaning solution composition for an engine combustion chamber which has excellent storage stability and effectively removes carbon deposits fixed inside a cylinder of an engine in order to solve the above problems.

In addition, an object of the present invention is to provide a method for cleaning an engine combustion chamber, in which cleaning is performed by removing at least one spark plug installed in an engine without disassembling the engine, and then injecting a cleaning solution for the engine combustion chamber, in order to effectively remove carbon deposits fixed inside the cylinder of the engine.

### Solution to Problem

In order to achieve the above-described objectives, the present invention provides an engine combustion chamber cleaning solution composition comprising water and EDTA.

In addition, the present invention provides a method for cleaning an engine combustion chamber, comprising:
a step of preparing an engine combustion chamber cleaning solution including, based on the total weight of the composition, 74 to 95 wt % of water, 0.5 to 10 wt % of EDTA-4Na, 0.5 to 5 wt % of sodium metasilicate pentahydrate, and 0.5 to 20 wt % of C11-14 ethoxylated propoxylated alcohol (Alcohols, (C=11-14)-iso-, (C=13)-rich, ethoxylated propoxylated) as a surfactant;
an engine combustion chamber cleaning solution injection step of injecting the cleaning solution into the cylinder of the engine through a spark plug mounting hole located at a portion from which at least one spark plug installed in the engine has been removed, without disassembling the automobile engine; and
a cleaning step in which the cylinder of the engine is immersed in the cleaning solution for a predetermined time so that the cleaning solution performs cleaning, thereby removing carbon deposits adhered to an upper portion of a piston and to a side oil ring inside the cylinder of the engine,
whereby an engine combustion chamber cleaning method is provided.

### Advantageous Effects of Invention

The cleaning solution composition for an engine combustion chamber according to the present invention has excellent storage stability and can effectively remove carbon deposits fixed inside the cylinder of the engine.

In addition, the method for cleaning an engine combustion chamber according to the present invention removes at least one spark plug installed in the engine without disassembling the engine, and then injects an engine combustion chamber cleaning solution to perform cleaning, thereby effectively removing carbon debris stuck inside the cylinder of the engine.

### BRIEF DESCRIPTION OF DRAWINGS

FIG. 1 is a photograph of a piston head used in the present invention and a piston head immersed in 500 ml of a cleaning solution according to Examples and Comparative Examples according to the present invention.

FIG. 2A is a photograph showing before and after cleaning of the piston head immersed in Example 1.

FIG. 2B is a photograph showing before and after cleaning of the piston head immersed in Example 2.

FIG. 2C is a photograph showing before and after cleaning of the piston head immersed in Example 3.

FIG. 3A is a photograph showing the piston head immersed in Comparative Example 1 before and after cleaning.

FIG. 3B is a photograph showing before and after cleaning the piston head immersed in Comparative Example 2.

FIG. 3C is a photograph showing before and after cleaning the piston head immersed in Comparative Example 3.

FIG. 3D is a photograph showing before and after cleaning the piston head immersed in Comparative Example 4.

FIG. 3E is a photograph showing before and after cleaning the piston head immersed in Comparative Example 5.

FIG. 3F is a photograph showing before and after cleaning of the piston head immersed in Comparative Example 6.

FIG. 3G is a photograph showing before and after cleaning the piston head immersed in Comparative Example 7.

FIG. 3H is a photograph showing before and after cleaning of the piston head immersed in Comparative Example 8.

FIG. 4A is a photograph showing the piston head immersed in Example 4 before and after cleaning.

FIG. 4B is a photograph showing before and after cleaning of the piston head immersed in Example 5.

FIG. 4C is a photograph showing before and after cleaning of the piston head immersed in Example 6.

FIG. 4D is a photograph showing before and after cleaning of the piston head immersed in Example 7.

FIG. 5A is a photograph showing the piston head immersed in Comparative Example 9 before and after cleaning.

FIG. 5B is a photograph showing before and after cleaning of the piston head immersed in Comparative Example 10.

FIG. 5C is a photograph showing before and after cleaning of the piston head immersed in Comparative Example 11.

FIG. 5D is a photograph showing before and after cleaning of the piston head immersed in Comparative Example 12.

FIG. 5E is a photograph showing before and after cleaning of the piston head immersed in Comparative Example 13.

FIG. 5F is a photograph showing before and after cleaning of the piston head immersed in Comparative Example 14.

FIG. 6 is a photograph showing before and after cleaning of the piston head immersed in Example 8.

FIG. 7A is a photograph showing before and after cleaning of the piston head immersed in Comparative Example 15.

FIG. 7B is a photograph showing before and after cleaning of the piston head immersed in Comparative Example 16.

FIG. 7C is a photograph showing before and after cleaning of the piston head immersed in Comparative Example 17.

FIG. 7D is a photograph showing before and after cleaning of the piston head immersed in Comparative Example 18.

FIG. 8A is a photograph showing before and after cleaning of the piston head immersed in Example 9.

FIG. 8B is a photograph showing before and after cleaning of the piston head immersed in Example 10.

FIG. 8C is a photograph showing before and after cleaning of the piston head immersed in Example 11.

FIG. 8D is a photograph showing before and after cleaning of the piston head immersed in Example 12.

FIG. 8E is a photograph showing before and after cleaning of the piston head immersed in Example 13.

FIG. 8F is a photograph showing before and after cleaning of the piston head immersed in Example 14.

FIG. 8G is a photograph showing before and after cleaning of the piston head immersed in Example 15.

FIG. 8H is a photograph showing before and after cleaning of the piston head immersed in Example 16.

FIG. 8I is a photograph showing before and after cleaning of the piston head immersed in Example 17.

FIG. 8J is a photograph showing before and after cleaning of the piston head immersed in Example 18.

FIG. 8K is a photograph showing before and after cleaning of the piston head immersed in Example 19.

FIG. 8L is a photograph showing before and after cleaning of the piston head immersed in Example 20.

FIG. 9A is a photograph showing before and after cleaning of the piston head immersed in Comparative Example 19.

FIG. 9B is a photograph showing before and after cleaning of the piston head immersed in Comparative Example 20.

FIG. 9C is a photograph showing before and after cleaning of the piston head immersed in Comparative Example 21.

FIG. 9D is a photograph showing before and after cleaning of the piston head immersed in Comparative Example 22.

FIG. 9E is a photograph showing before and after cleaning of the piston head immersed in Comparative Example 23.

FIG. 9F is a photograph showing before and after cleaning of the piston head immersed in Comparative Example 24.

FIG. 9G is a photograph showing before and after cleaning of the piston head immersed in Comparative Example 25.

FIG. 9H is a photograph showing before and after cleaning of the piston head immersed in Comparative Example 26.

FIG. 9I is a photograph showing before and after cleaning of the piston head immersed in Comparative Example 27.

FIG. 9J is a photograph showing before and after cleaning of the piston head immersed in Comparative Example 28.

FIG. 9K is a photograph showing before and after cleaning of the piston head immersed in Comparative Example 29.

FIG. 9L is a photograph showing before and after cleaning of the piston head immersed in Comparative Example 30

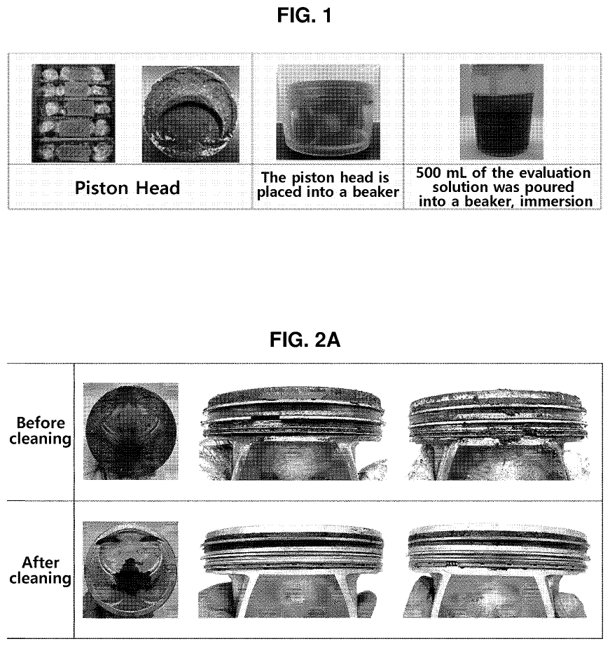

### BEST MODE FOR CARRYING OUT THE INVENTION

An engine combustion chamber cleaning solution composition comprising water and EDTA.

### MODE FOR CARRYING OUT THE INVENTION

Hereinafter, the present invention will be described in more detail.

The present invention relates to an engine combustion chamber cleaning solution composition comprising water and EDTA.

In an embodiment of the present invention, the engine combustion chamber cleaning solution composition may include 94 to 99.5 wt %, 94 to 98.5 wt %, 94 to 97.5 wt %, 95 to 99.5 wt %, 95 to 98.5 wt %, 95 to 97.5 wt % of the water, and 0.5 to 6 wt %, 0.5 to 5 wt %, 0.5 to 4 wt %, 0.5 to 3 wt %, 1 to 6 wt %, 1 to 5 wt %, 1 to 4 wt %, or 1 to 3 wt % of the EDTA, based on the total weight of the composition, but may include, for example, 97 wt % of the water and 3 wt % of the EDTA, but is not limited thereto.

In an embodiment of the present invention, the engine combustion chamber cleaning solution composition may include 72 to 96 wt %, 72 to 94 wt %, 72 to 92 wt %, 72 to 90 wt %, 76 to 96 wt %, 76 to 94 wt %, 76 to 92 wt %, 76 to 90 wt %, 80 to 96 wt %, 80 to 94 wt %, 80 to 92 wt %, 80 to 90 wt %, 84 to 96 wt %, 84 to 94 wt %, 84 to 92 wt %, 84 to 90 wt %, 88 to 96 wt %, 88 to 94 wt %, 88 to 92 wt %, 88 to 90 wt %, 90 to 96 wt %, 90 to 94 wt %, or 90 to 92 wt % of water, and 0.5 to 25 wt %, 0.5 to 20 wt %, 0.5 to 15 wt %, 0.5 to 10 wt %, 0.5 to 5 wt %, 1 to 25 wt %, 1 to 20 wt %, 1 to 15 wt %, 1 to 10 wt %, or 1 to 5 wt % of EDTA, based on the total weight of the composition, and may further include 0.5 to 5 wt %, 0.5 to 4 wt %, 0.5 to 3 wt %, 0.5 to 2 wt %, 0.5 to 1 wt %, 1 to 5 wt %, 1 to 4 wt %, 1 to 3 wt %, or 1 to 2 wt % of sodium metasilicate, based on the total weight of the composition, and may include, for example, 94 wt % of water and 5 wt % of EDTA, and may further include 1 wt % of sodium metasilicate, but is not limited thereto.

In an embodiment of the present invention, the engine combustion chamber cleaning solution composition may include 85 to 93 wt %, 85 to 92 wt %, 85 to 91 wt %, 88 to 93 wt %, 88 to 92 wt %, or 88 to 91 wt % of water, and 2 to 10 wt %, 2 to 8 wt %, 2 to 6 wt %, 4 to 10 wt %, 4 to 8 wt %, or 4 to 6 wt % of EDTA, based on the total weight of the composition, and may further include 4 to 6 wt %, 4 to 5 wt %, or 5 to 6 wt % of a surfactant, based on the total weight of the composition, and may include, for example, 90 wt % of water and 5 wt % of EDTA, and may further include 5 wt % of a surfactant, but is not limited thereto.

In an embodiment of the present invention, the engine combustion chamber cleaning solution composition may include 74 to 95 wt %, 74 to 93 wt %, 74 to 91 wt %, 74 to 89 wt %, 77 to 95 wt %, 77 to 93 wt %, 77 to 91 wt %, 77 to 89 wt %, 80 to 95 wt %, 80 to 93 wt %, 80 to 91 wt %, 80 to 89 wt %, 83 to 95 wt %, 83 to 93 wt %, 83 to 91 wt %, 83 to 89 wt %, 86 to 95 wt %, 86 to 93 wt %, 86 to 91 wt %, or 86 to 89 wt % of water, and 0.5 to 10 wt %, 0.5 to 9 wt %, 0.5 to 8 wt %, 0.5 to 7 wt %, 0.5 to 6 wt %, 0.5 to 5 wt %, 1 to 10 wt %, 1 to 9 wt %, 1 to 8 wt %, 1 to 7 wt %, 1 to 6 wt %, 1 to 5 wt %, 2 to 10 wt %, 2 to 9 wt %, 2 to 8 wt %, 2 to 7 wt %, 2 to 6 wt %, 2 to 5 wt %, 3 to 10 wt %, 3 to 9 wt %, 3 to 8 wt %, 3 to 7 wt %, 3 to 6 wt %, 3 to 5 wt %, 4 to 10 wt %, 4 to 9 wt %, 4 to 8 wt %, 4 to 7 wt %, 4 to 6 wt %, or 4 to 5 wt % of EDTA, based on the total weight of the composition, and may further include 0.5 to 5 wt %, 0.5 to 4.5 wt %, 0.5 to 4 wt %, 0.5 to 3.5 wt %, 0.5 to 3 wt %, 0.5 to 2.5 wt %, 0.5 to 2 wt %, 0.5 to 1.5 wt %, 0.5 to 1 wt %, 1 to 5 wt %, 1 to 4.5 wt %, 1 to 4 wt %, 1 to 3.5 wt %, 1 to 3 wt %, 1 to 2.5 wt %, 1 to 2 wt %, or 1 to 1.5 wt % of sodium metasilicate, and 0.5 to 20 wt %, 0.5 to 16 wt %, 0.5 to 12 wt %, 0.5 to 8 wt %, 0.5 to 6 wt %, 1 to 20 wt %, 1 to 16 wt %, 1 to 12 wt %, 1 to 8 wt %, 1 to 6 wt %, 1.5 to 20 wt %, 1.5 to 16 wt %, 1.5 to 12 wt %, 1.5 to 8 wt %, 1.5 to 6 wt %, 2 to 20 wt %, 2 to 16 wt %, 2 to 12 wt %, 2 to 8 wt %, 2 to 6 wt %, 4 to 20 wt %, 4 to 16 wt %, 4 to 12 wt %, 4 to 8 wt %, or 4 to 6 wt % of a surfactant, based on the total weight of the composition, and may include, for example, 89 wt % of water and 5 wt % of EDTA, and may further include 1 wt % of sodium metasilicate and 5 wt % of a surfactant, but is not limited thereto.

When the cleaning solution composition of the engine combustion chamber is composed of four or more components including a solvent, there may be a problem in that the cleaning power of the cleaning solution composition is deteriorated when the EDTA content is less than 0.5 wt %, and there may be a problem in that the piston head is discolored when it exceeds 10 wt %.

When the cleaning solution composition of the engine combustion chamber includes four or more components including a solvent, when the sodium metasilicate content is less than 0.5 wt %, there may be a problem in that the cleaning ability of EDTA, which is an additive, is deteriorated, and when the content is greater than 5 wt %, there may be a problem in that the generation of deposits of the piston head is promoted.

When the cleaning solution composition of the engine combustion chamber is composed of four or more components including a solvent, there may be a problem in that the cleaning power of the cleaning solution composition is lowered when the surfactant content is less than 0.5 wt %, and there may be a problem in that corrosion is generated in the piston head when the surfactant content is greater than 20 wt %.

In one embodiment of the present invention, the surfactant comprises at least one selected from the group consisting of C11-14 ethoxylated propoxylated alcohol (Alcohols, (C=11-14)-iso-, (C=13)-rich, ethoxylated propoxylated), C12-14 ethoxylated alcohols (Ethoxylated alcohols (C=12-14)), ammonium lauryl sulfate, sodium ethylhexyl sulfate, sodium xylenesulfonate, sodium laureth sulfate and polyoxyethylene sorbitan monooleate, but is not limited thereto.

In an embodiment of the present invention, the engine combustion chamber cleaning solution composition further comprises 0.5 to 5 wt %, 0.5 to 4.5 wt %, 0.5 to 4 wt %, 0.5 to 3.5 wt %, 0.5 to 3 wt %, 0.5 to 2.5 wt %, 0.5 to 2 wt %, 0.5 to 1.5 wt %, 0.5 to 1 wt %, 1 to 5 wt %, 1 to 4.5 wt %, 1 to 4 wt %, 1 to 3.5 wt %, 1 to 3 wt %, 1 to 2.5 wt %, 1 to 2 wt %, 1 to 1.5 wt %, of an additional additive based on the total weight of the composition, wherein the additional additive comprises at least one selected from the group consisting of 3-methyl-3-methoxybutanol, N,N-dimethyl-1-dodecylamine N-oxide, sodium lauryl polyoxyethylene ether sulfate, sodium phosphate tribasic dodecahydrate, C9-11 ethoxylated alcohols (Ethoxylated alcohols (C=9-11)), dimethylalkylamine N-oxide, cocamidopropyl betaine, 2-methoxypropanol, N,N-dimethyl-1-dodecanamine N-oxide, sodium dodecylbenzenesulfonate, polyoxyethylene tridecyl ether, 2-ethylhexanol EO-PO nonionic surfactant, N,N-dimethyl 9-decenamide and sodium gluconate, but is not limited thereto.

In an embodiment of the present invention, EDTA may be any one selected from the group consisting of EDTA-2Na dihydrate, EDTA-2Na tetrahydrate, EDTA-4Na dihydrate, and EDTA-4Na tetrahydrate, but is not limited thereto.

In an embodiment of the present invention, the sodium metasilicate may be any one selected from the group consisting of sodium metasilicate anhydrous, sodium metasilicate pentahydrate, and sodium metasilicate nonahydrate, but is not limited thereto.

In an embodiment of the present disclosure, the pH of the engine combustion chamber cleaning solution composition may be 10 to 13, 10 to 12, 10 to 11, 11 to 13, 11 to 12, for example, 12 to 13, but is not limited thereto.

The present invention relates to a method for cleaning an engine combustion chamber, comprising: a step of preparing an engine combustion chamber cleaning solution including, based on the total weight of the composition, 74 to 95 wt % of water, 0.5 to 10 wt % of EDTA-4Na, 0.5 to 5 wt % of sodium metasilicate pentahydrate, and 0.5 to 20 wt % of C11-14 ethoxylated propoxylated alcohol (Alcohols, (C=11-14)-iso-, (C=13)-rich, ethoxylated propoxylated) as a surfactant;

an engine combustion chamber cleaning solution injection step of injecting the cleaning solution into the cylinder of the engine through a spark plug mounting hole located at a portion from which at least one spark plug installed in the engine has been removed, without disassembling the automobile engine; a cleaning step in which the cylinder of the engine is immersed in the cleaning solution for a predetermined time so that the cleaning solution performs cleaning, thereby removing carbon deposits adhered to an upper portion of a piston and to a side oil ring inside the cylinder of the engine.

In an embodiment of the present disclosure, in the cleaning step of the engine combustion chamber cleaning method, the cylinder of the engine is cleaned by the engine combustion chamber cleaning solution while the cylinder is immersed in the cleaning liquid at room temperature for 2 to 18 hours, 2 to 16 hours, 2 to 14 hours, 2 to 12 hours, 2 to 10 hours, 2 to 8 hours, 2 to 6 hours, 4 to 18 hours, 4 to 16 hours, 4 to 14 hours, 4 to 12 hours, 4 to 8 hours, 4 to 6 hours, 5 to 18 hours, 5 to 16 hours, 5 to 14 hours, 5 to 12 hours, 5 to 10 hours, 5 to 8 hours, 5 to 6 hours, for example, 6 hours, but is not limited thereto.

In an embodiment of the present disclosure, in the method for cleaning an engine combustion chamber, the engine combustion chamber cleaning solution is used in an amount of 50 to 550 mL, 50 to 450 mL, 50 to 350 mL, 50 to 250 mL, 50 to 150 mL, 100 to 550 mL, 100 to 450 mL, 100 to 350 mL, 100 to 250 mL, 100 to 150 mL, for example, 100 mL, but is not limited thereto.

In an embodiment of the present disclosure, the EDTA-4Na of the engine combustion chamber cleaning method may be EDTA-4Na dihydrate or EDTA-4Na tetrahydrate, but is not limited thereto.

In an embodiment of the present disclosure, the pH of the engine combustion chamber cleaning solution may be 10 to 13, 10 to 12, 10 to 11, 11 to 13, 11 to 12, for example, 12 to 13, but is not limited thereto.

Hereinafter, in order to help understanding of the present invention, it will be described in detail with reference to the following embodiments. However, the embodiments according to the present disclosure may be modified in various different forms, and the scope of the present disclosure should not be construed as being limited to the embodiments described below. Embodiments of the present invention are exemplarily provided to help a detailed understanding of the present invention.

### PREPARATION OF EXAMPLES AND COMPARATIVE EXAMPLES

Specific components of the ingredient names used in the examples and the comparative examples are as follows:
Water (CAS No. 7732-18-5)
SMC: Sodium metasilicate pentahydrate (CAS No. 10213-79-3)
EDTA: EDTA-4Na (Ethylenediamine tetra acetic acid, tetrasodium salt) dihydrate (CAS No. 10378-23-1) or EDTA-4Na tetrahydrate (CAS No. 13235-36-4)
C11-14 Ethoxylated Propoxylated Alcohol: Alcohols, (C=11-14)-iso-, (C=13)-rich, ethoxylated propoxylated (CAS No. 78330-23-1)
C12-14 Ethoxylated Alcohol: Alcohols, C=12-14, ethoxylated (CAS No. 68439-50-9)
BDG: Diethylene glycol butyl ether (CAS No. 112-34-5)
MDG: diethylene glycol dimethyl ether (CAS No. 111-96-6)
MG: ethylene glycol monomethyl ether (CAS No. 109-86-4)
Limonene: D-LIMONENE (CAS No. 5989-27-5)
IPA: Isopropyl alcohol (CAS No. 67-63-0)
PP: Potassium phosphate monobasic (CAS No. 7778-77-0)
TEA: Triethanolamine (CAS No. 102-71-6)
TTA: 4-Methyl-1H-benzotriazole (CAS No. 29385-43-1)
Mannitol (CAS No. 69-65-8)
Sorbitol (CAS No. 50-70-4)
SN: Sodium nitrite (CAS No. 7632-00-0)
SA: Sodium acetate (CAS No. 127-09-3)
PA: Potassium acetate (CAS No. 127-08-2)

Each of Examples and Comparative Examples having the compositions shown in Tables 1 to 5 below was prepared by mixing the compositions in respective wt % based on the total weight of 100 of the composition.

### Examples 1 to 3 and Comparative Examples 1 to 8

To evaluate the carbon cleaning performance of mixture composed of EDTA as an additive and a solvent, cleaning solutions consisting of Examples 1 to 3 and Comparative Examples 1 to 8 of the following Table 1 were prepared.

TABLE 1

| Ingredients/ | | Example | | | comparative example | | | | | | | |
|---|---|---|---|---|---|---|---|---|---|---|---|---|
| Content (wt %) | | 1 | 2 | 3 | 1 | 2 | 3 | 4 | 5 | 6 | 7 | 8 |
| solvent | water | 99 | 97 | 95 | 90 | 49 | 49 | 9 | 100 | | | |
| | BDG | | | | | | | | | 100 | | |
| | MDG | | | | | 50 | | | | | 100 | |
| | MG | | | | | | 50 | | | | | 100 |
| | IPA | | | | | | | 50 | | | | |
| Additive | EDTA | 1 | 3 | 5 | | 1 | 1 | 1 | | | | |
| | SMC | | | | 10 | | | | | | | |
| | Limonene | | | | | | | 40 | | | | |

| | | | | | | | | | | | |
|---|---|---|---|---|---|---|---|---|---|---|---|
| Total | 100 | 100 | 100 | 100 | 100 | 100 | 100 | 100 | 100 | 100 | 100 |

### Examples 4 to 7 and Comparative Examples 9 to 14

To evaluate the carbon cleaning performance of a mixture composed of water as a solvent and EDTA and sodium metasilicate as additives, cleaning solutions consisting of Examples 4 to 7 and Comparative Examples 9 to 14 of the following Table 2 were prepared.

TABLE 2

| Ingredients/ | | Example | | | | Comparative example | | | | | |
|---|---|---|---|---|---|---|---|---|---|---|---|
| Content (wt %) | | 4 | 5 | 6 | 7 | 9 | 10 | 11 | 12 | 13 | 14 |
| solvent | water | 94 | 94.5 | 92 | 90 | 94.7 | 88 | 96 | 96 | 96 | 94 |
| Additive | EDTA | 5 | 5 | 5 | 5 | 5 | 5 | | | | |
| | SMC | 1 | 0.5 | 3 | 5 | 0.3 | 7 | 1 | 1 | 1 | 1 |
| | PHOSPHORIC ACID | | | | | | | 3 | | | |
| | (CAS No. 7664-38-2) | | | | | | | | | | |
| | CITRIC ACID | | | | | | | | 3 | | |
| | (CAS No. 77-92-9) | | | | | | | | | | |
| | Sodium bicarbonate | | | | | | | | | 3 | |
| | (CAS No. 144-55-8) | | | | | | | | | | |
| | Betaine | | | | | | | | | | 5 |
| | (CAS No. 107-43-7) | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |

### Examples 8 and Comparative Examples 15 to 18

To evaluate the carbon cleaning performance of a mixture composed of water as a solvent and EDTA and surfactant as additives, cleaning solutions consisting of Examples 8 and Comparative Examples 15 to 18 of the following Table 3 were prepared.

TABLE 3

| Ingredients/ | | Example | comparative example | | | |
|---|---|---|---|---|---|---|
| Content (wt %) | | 8 | 15 | 16 | 17 | 18 |
| solvent | water | 90 | 88 | 85 | 92 | 85 |
| Additive | EDTA | 5 | 5 | 5 | 5 | 5 |
| surfactant | C11-14 Ethoxylated | 5 | 7 | 10 | | |
| | propoxylated alcohol | | | | | |
| | C12-14 Ethoxylated alcohol | | | | 3 | |
| | (CAS No. 68439-50-9) | | | | | |
| | Sodium ethylhexylsulfate | | | | | 10 |
| | (CAS No. 126-92-1) | | | | | |

| | | | | | |
|---|---|---|---|---|---|
| Total | 100 | 100 | 100 | 100 | 100 |

### Examples 9 to 20 and Comparative Examples 19 to 30

To evaluate the carbon cleaning performance of a mixture composed of water as a solvent and EDTA, sodium metasilicate and surfactant as additives, cleaning solutions consisting of Examples 9 to 20 of the following Table 4, and Comparative Examples 19 to 30 of the following Table 5 were prepared.

TABLE 4

| Ingredients/Content | | Example | | | | | | | | | | | |
|---|---|---|---|---|---|---|---|---|---|---|---|---|---|
| (wt %) | | 9 | 10 | 11 | 12 | 13 | 14 | 15 | 16 | 17 | 18 | 19 | 20 |
| solvent | water | 91 | 90 | 89 | 84 | 79 | 74 | 93.5 | 87 | 84 | 94 | 91.5 | 80 |
| Additive | EDTA | 3 | 4 | 5 | 5 | 5 | 5 | 0.5 | 7 | 10 | 0.5 | 0.5 | 10 |
| | SMC | 1 | 1 | 1 | 1 | 1 | 1 | 1 | 1 | 1 | 0.5 | 3 | 5 |
| surfactant | C11-14 | 5 | 5 | 5 | 10 | 15 | 20 | 5 | 5 | 5 | 5 | 5 | 5 |
| | Ethoxylated | | | | | | | | | | | | |
| | propoxylated | | | | | | | | | | | | |
| | alcohol | | | | | | | | | | | | |

| | | | | | | | | | | | | |
|---|---|---|---|---|---|---|---|---|---|---|---|---|
| Total | 100 | 100 | 100 | 100 | 100 | 100 | 100 | 100 | 100 | 100 | 100 | 100 |

TABLE 5

| Ingredients/Content | | comparative example | | | | | | | | | | | |
|---|---|---|---|---|---|---|---|---|---|---|---|---|---|
| (wt %) | | 19 | 20 | 21 | 22 | 23 | 24 | 25 | 26 | 27 | 28 | 29 | 30 |
| solvent | water | 94 | 89 | 94.7 | 89 | 89 | 89 | 89 | 89 | 89 | 84 | 84 | 64 |
| Additive | SMC | 1 | 6 | 0.3 | 1 | 1 | 1 | 1 | 1 | 1 | 1 | 1 | 1 |
| | Additive | — | — | — | PP 5 | TEA 5 | TTA 5 | Mannitol 5 | Sorbitol 5 | SN 5 | SA 10 | PA 10 | EDTA 5 |
| surfactant | C11-14 | 5 | 5 | 5 | 5 | 5 | 5 | 5 | 5 | 5 | — | — | 30 |
| | Ethoxylated | | | | | | | | | | | | |
| | propoxylated | | | | | | | | | | | | |
| | alcohol | | | | | | | | | | | | |
| | C12-14 | — | — | — | — | — | — | — | — | — | 5 | 5 | — |
| | Ethoxylated | | | | | | | | | | | | |
| | alcohol | | | | | | | | | | | | |

| | | | | | | | | | | | | |
|---|---|---|---|---|---|---|---|---|---|---|---|---|
| Total | 100 | 100 | 100 | 100 | 100 | 100 | 100 | 100 | 100 | 100 | 100 | 100 |

### Evaluation of Examples and Comparative Examples

In order to evaluate the carbon cleaning power in the combustion chamber of the engine with the cleaning solution compositions prepared through the examples and comparative examples, 1 ea of the piston head of the Theta 2 GDI engine (driving distance 106,936 Km to 121,670 km) of Hyundai Motor Company was immersed in the cleaning solution composition 500 mL and left at room temperature for 16 hours to confirm the effect of removing carbon fixed around the deposited piston head, and the evaluation results are shown according to the evaluation criteria table presented in Table 6 below.

The evaluation result of “whether to remove the oil ring carbon” was evaluated as the removal of the oil ring carbon when the carbon was completely removed and the oil hole of the oil ring part was visible by evaluating whether the fixed carbon of the oil ring groove of the side part of the piston head was removed,
and the evaluation result of “the carbon removal rate excluding the oil ring” was evaluated as the carbon removal rate of the entire piston head excluding the oil ring.

TABLE 6

| mark | |
|---|---|
| symbol | Evaluation Results |
| ⊚ | Very good cleaning power (carbon removal rate of 80% or more) |
| ◯ | Good cleaning power (carbon removal rate of 40% or more and |
| | less than 80%) |
| Δ | Cleaning power normal (carbon removal rate of 10% or more |
| | and less than 40%) |
| X | Poor cleaning power (carbon removal rate less than 10%) |
| XX | Very poor cleaning power (carbon not removed) |

### 1. Evaluation of Carbon Cleaning of Solvents and EDTA Mixtures

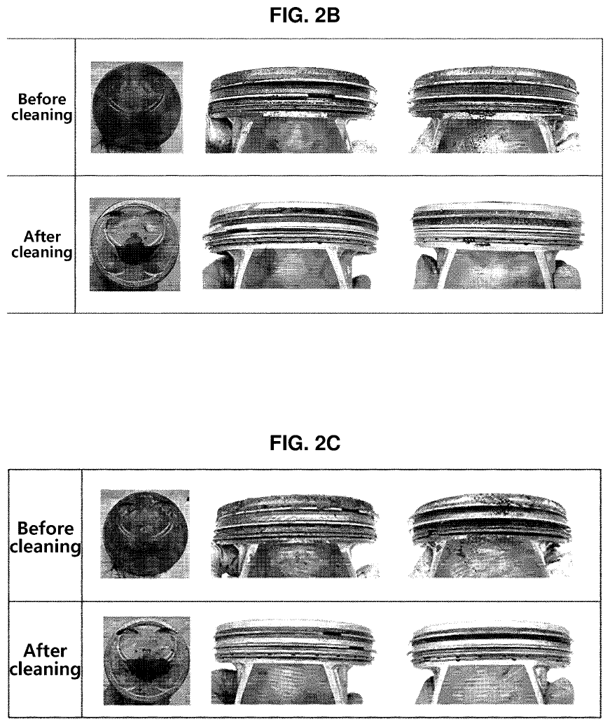

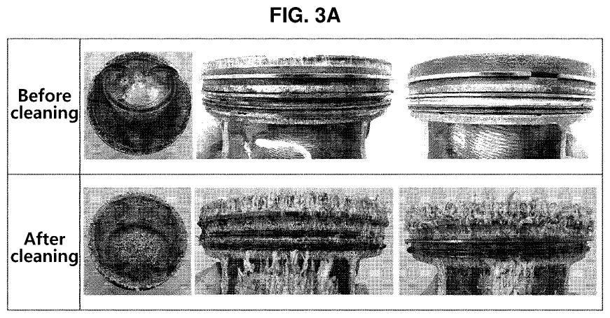

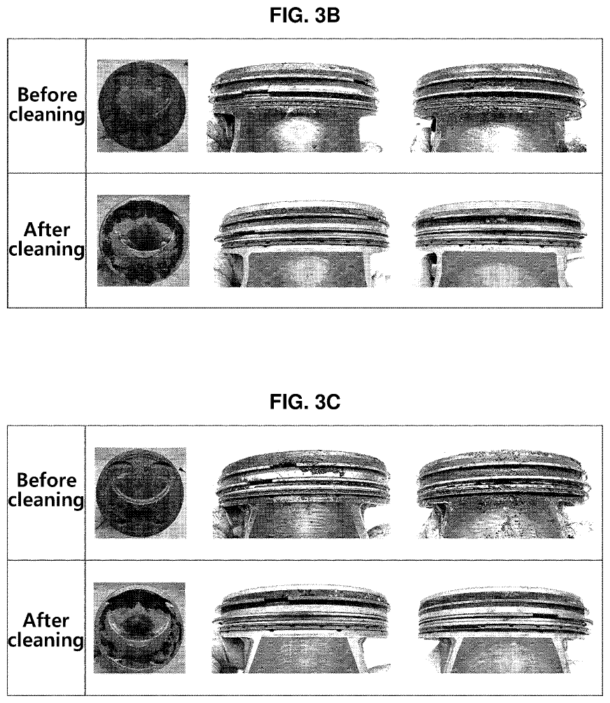

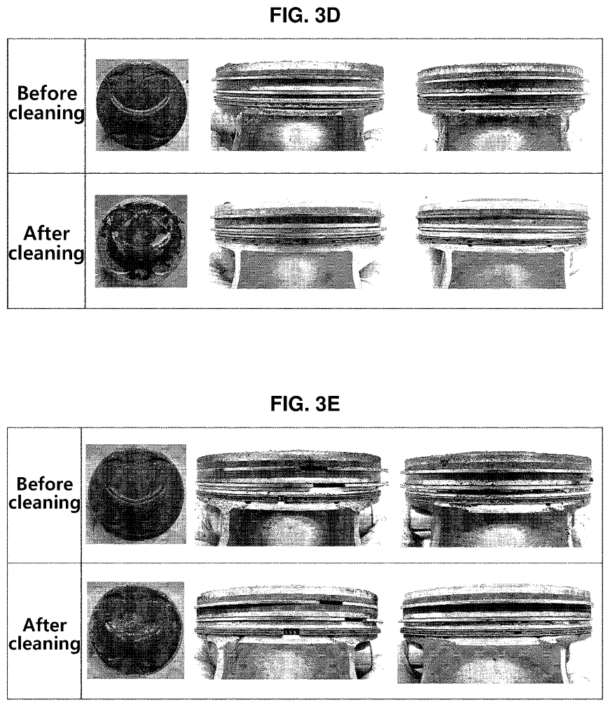

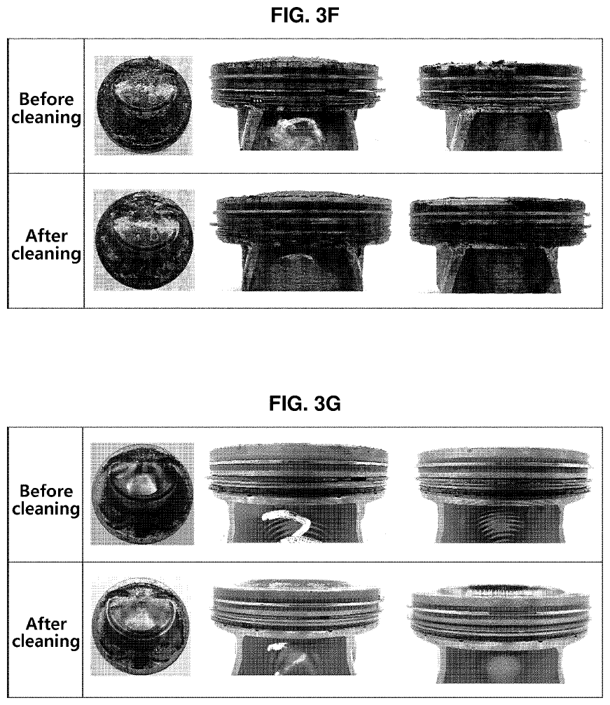

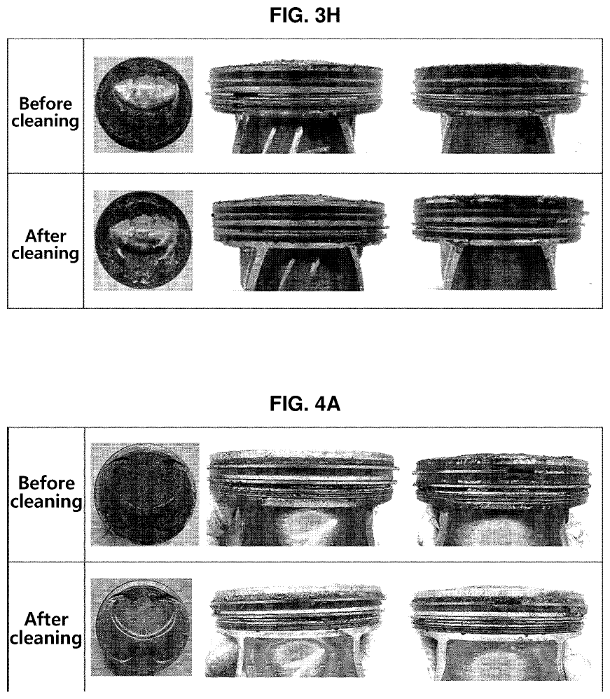

Through each of the Examples and Comparative Examples composed of Table 1, the carbon removal rate of the piston head of the mixture or solvent alone containing the additive including the solvent and EDTA was checked, the results are shown in Table 7 below, and pictures before and after cleaning are shown in FIGS. 2A-2C and 3A-3H.

TABLE 7

| | Whether the oil ring | Carbon Removal Rate |
|---|---|---|
| | carbon is removed | Excluding Oil ring |
| Example 1 | Removed | ◯ |
| Example 2 | Removed | ◯ |
| Example 3 | Removed | ◯ |
| Comparative | Removed | Δ(Discoloration, |
| Example 1 | | Corrosion generation) |
| Comparative | Removed | Δ |
| Example 2 | | |
| Comparative | Removed | Δ |
| Example 3 | | |
| Comparative | Removed | Δ |
| Example 4 | | |
| Comparative | Not Removed | X |
| Example 5 | | |
| Comparative | Not Removed | X |
| Example 6 | | |
| Comparative | Not Removed | X |
| Example 7 | | |
| Comparative | Not Removed | X |
| Example 8 | | |

As shown in Table 7, FIGS. 2A-2C, and 3A-3H of the present invention, the case of the cleaning solutions (Examples 1 to 3), which are a mixture of water and EDTA as an additive as a solvent, showed a higher carbon removal rate than the cleaning solution containing water and sodium metasilicate (Comparative Example 1), the cleaning solution containing other solvents other than water (Comparative Examples 2 to 4), or the solvent alone containing only water (Example 5) or not containing water (Examples 6 to 8), and in particular, the cleaning solution containing EDTA as an additive (Examples 1 to 3 and Comparative Examples 2 to 4) showed an effect of removing up to carbon in oil ring.

In addition, EDTA included both EDTA-4Na dihydrate and EDTA-4Na tetrahydrate as examples, so that similar cleaning results could be confirmed as experimental results, and the following examples and comparative examples were performed by including EDTA as EDTA-4Na dihydrate and EDTA-4Na tetrahydrate, respectively.

### 2. Evaluation of Carbon Cleaning of Mixture of Water, EDTA, and Sodium Metasilicate

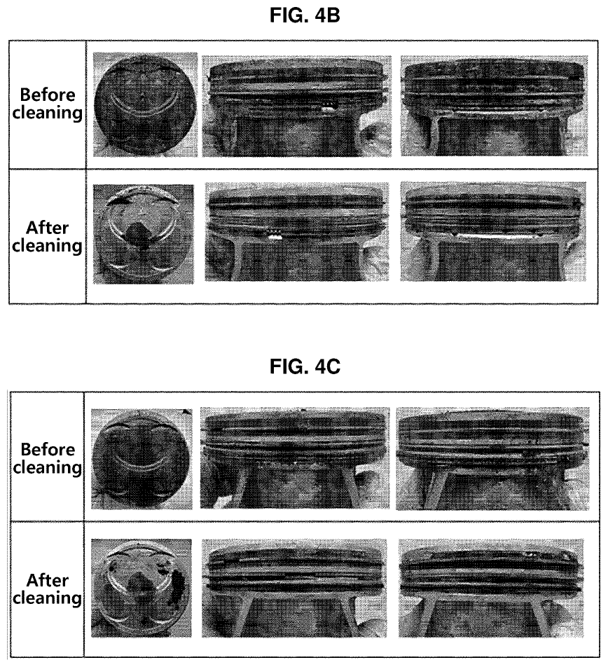

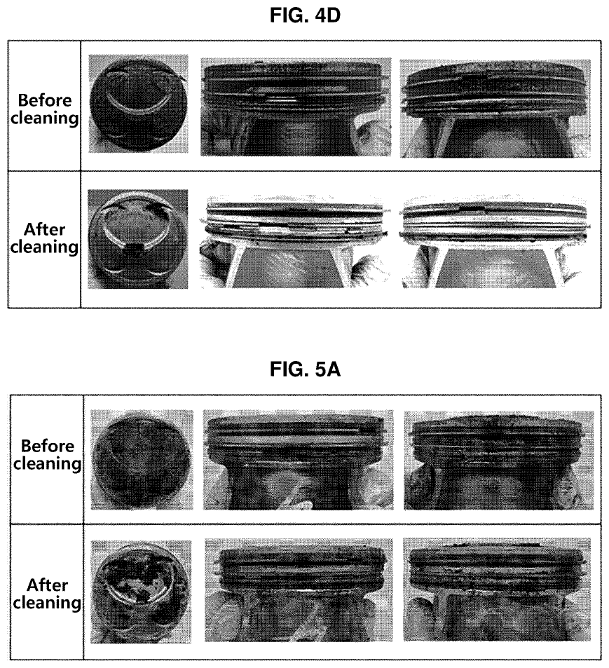

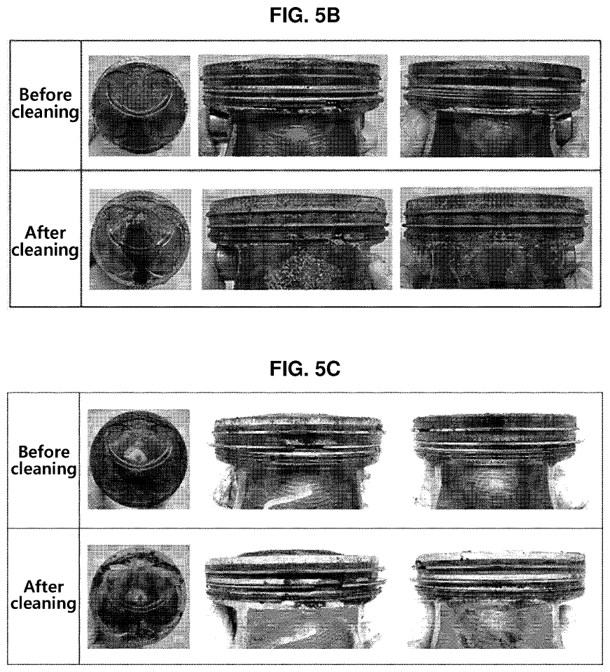

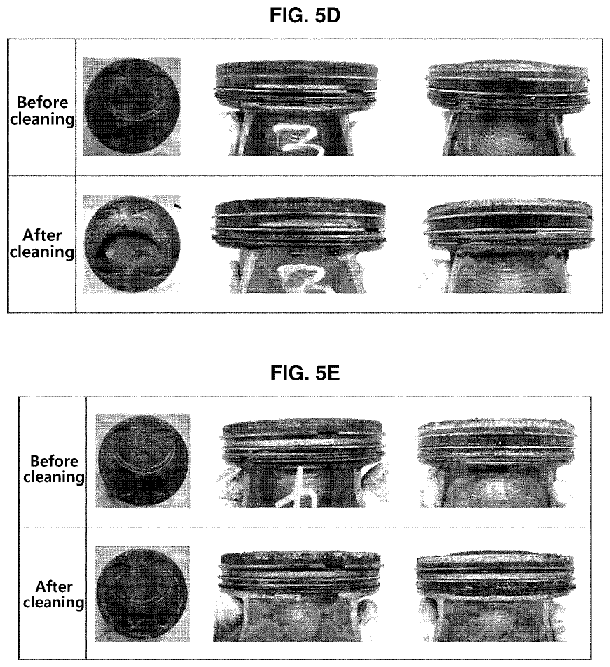

Through each of the examples and comparative examples composed of Table 2, the carbon removal rate of the piston head of the mixture including water, EDTA, and sodium metasilicate was checked, the results are shown in Table 8 below, and pictures before and after cleaning are shown in FIGS. 4A-4D and 5A-5F.

TABLE 8

| | Whether the oil ring | Carbon Removal Rate |
|---|---|---|
| | carbon is removed | Excluding Oil ring |
| Example 4 | Removed | ⊚ |
| Example 5 | Removed | ◯ |
| Example 6 | Removed | ⊚ |
| Example 7 | Removed | ⊚ |
| Comparative | Not Removed | Δ |
| Example 9 | | |
| Comparative | Not Removed | Δ(Corrosion generation) |
| Example 10 | | |
| Comparative | Not Removed | Δ |
| Example 11 | | |
| Comparative | Not Removed | XX |
| Example 12 | | |
| Comparative | Not Removed | XX |
| Example 13 | | |
| Comparative | Not Removed | X |
| Example 14 | | |

As can be seen in Table 8, FIGS. 4A-4D and 5A-5F of the present invention, Examples 4 to 7 of the present invention, which are cleaning solutions containing all three mixtures of water as a solvent, EDTA as an additive, and sodium metasilicate, showed higher carbon removal rates than cleaning solutions (Comparative Examples 9 and 10) which are mixtures that deviate from the content of sodium metasilicate of the present invention, or cleaning solutions (Comparative Examples 11 to 14) which are mixtures containing other additives other than EDTA.

### 3. Evaluation of Carbon Cleaning of Mixture of Water, EDTA and Surfactant

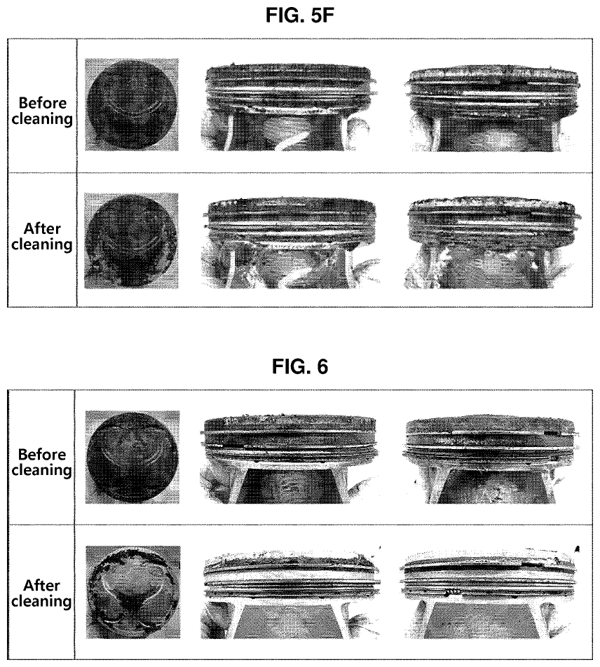

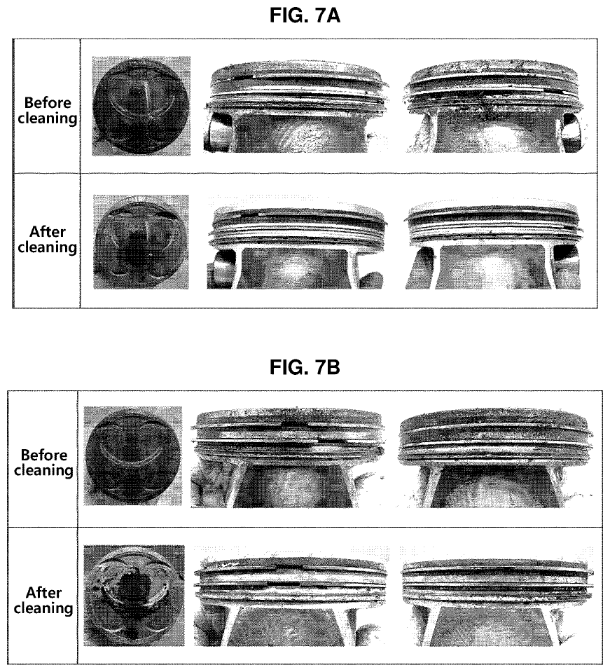

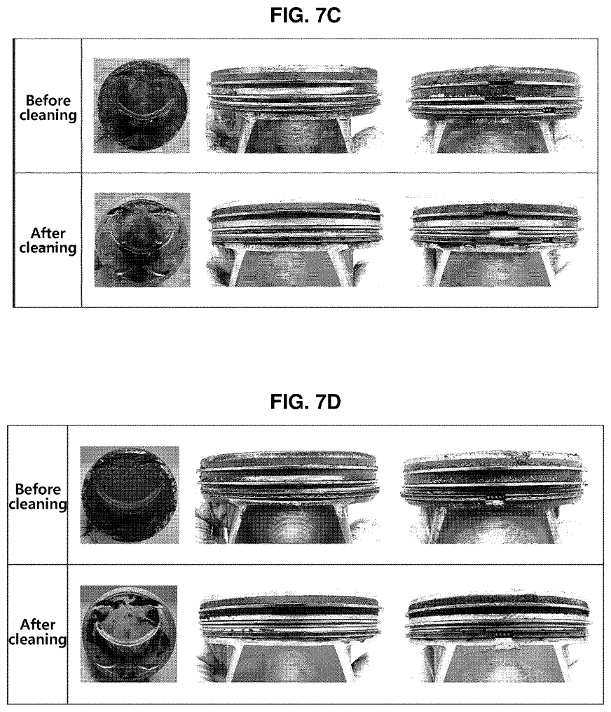

In each of the examples and comparative examples composed of Table 3, the carbon removal rate of the piston head of the cleaning solution, which is a mixture including water, EDTA, and a surfactant, was confirmed, the results are shown in Table 9 below, and pictures before and after cleaning are shown in FIGS. 6 and 7A-7D.

TABLE 9

| | Whether the oil ring | Carbon Removal Rate |
|---|---|---|
| | carbon is removed | Excluding Oil ring |
| Example 8 | Removed | ⊚ |
| Comparative | Removed | Δ |
| Example 15 | | |
| Comparative | Removed | ◯ |
| Example 16 | | |
| Comparative | Removed | ◯ |
| Example 17 | | |
| Comparative | Removed | ◯ |
| Example 18 | | |

As can be seen in Tables 9, FIGS. 6, and 7A-7D of the present invention, when the surfactant is included, the carbon removal rate is basically higher than a predetermined level, but in particular, the case of Example 8 of the present invention, which includes a mixture of water, EDTA, and a C11-14 ethoxylated propoxylated alcohol as the surfactant, showed a higher carbon removal rate than the cleaning solution (Comparative Examples 15 to 18), which includes the surfactant but deviates from the content of the present invention.

### 4. Evaluation of Carbon Cleaning of Water, EDTA, Sodium Metasilicate and Surfactant Mixture;

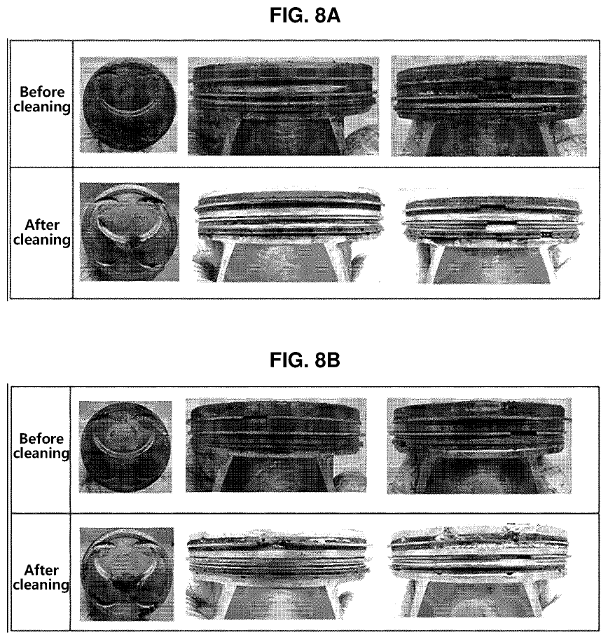

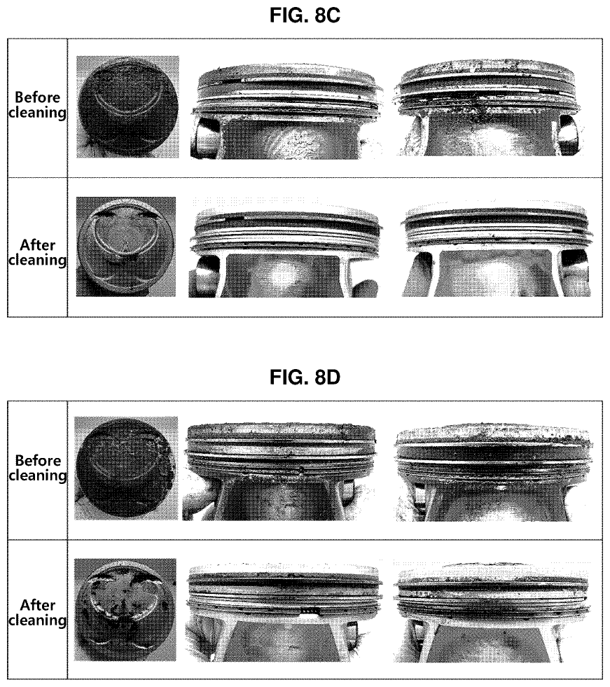

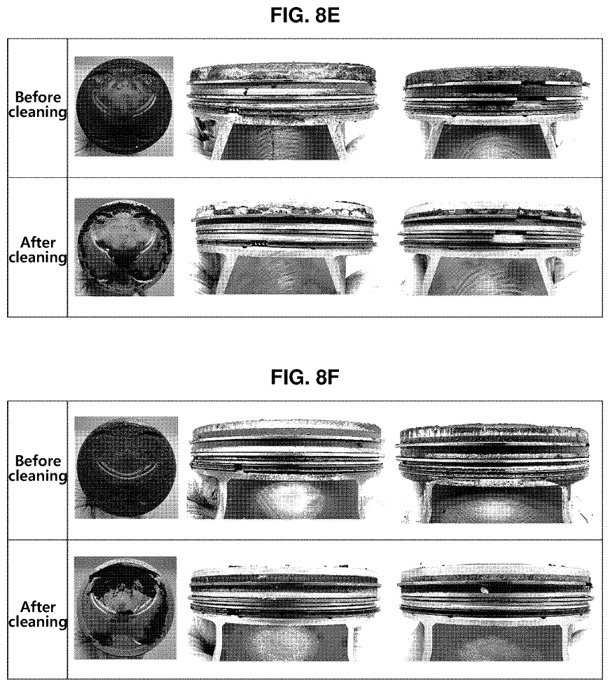

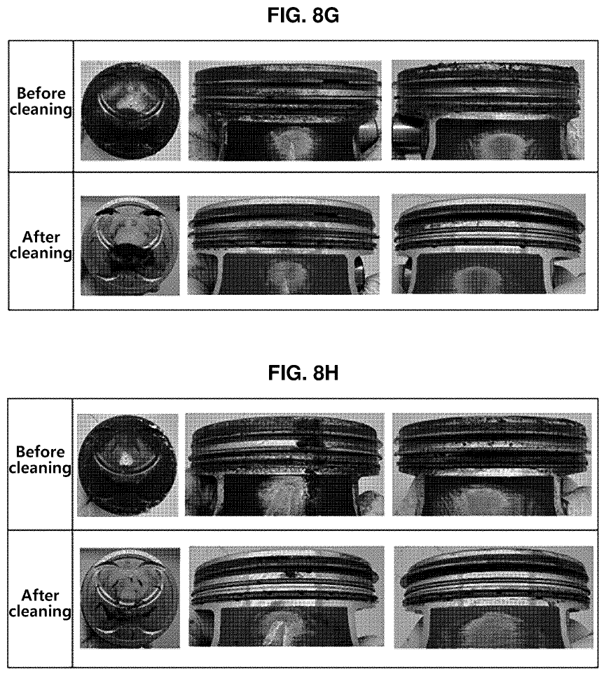

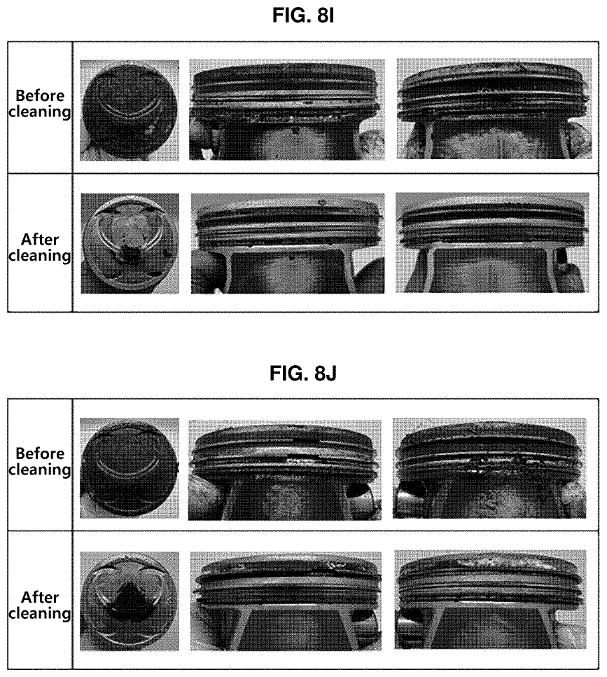

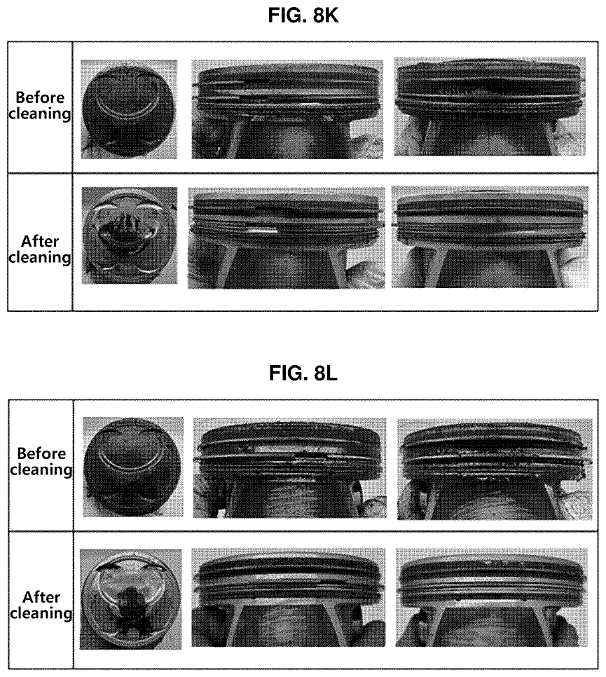

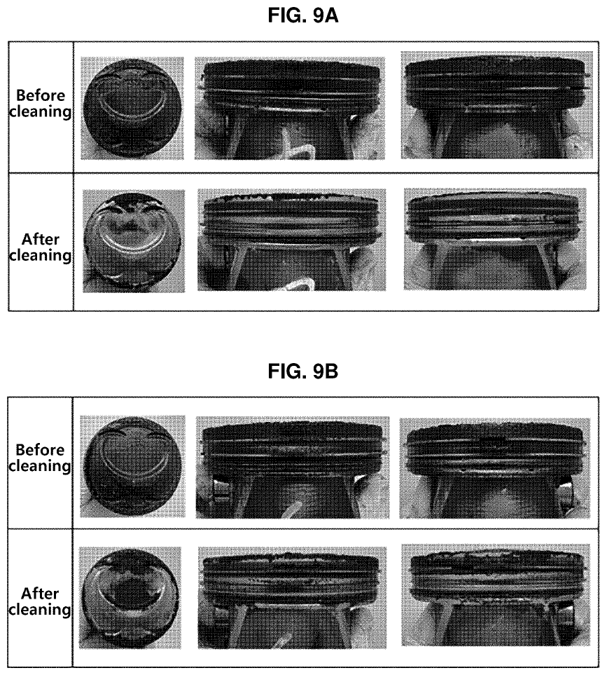

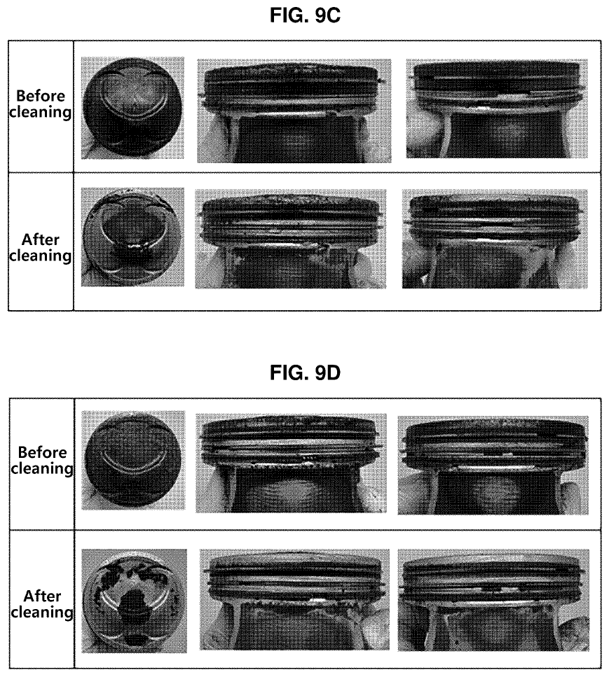

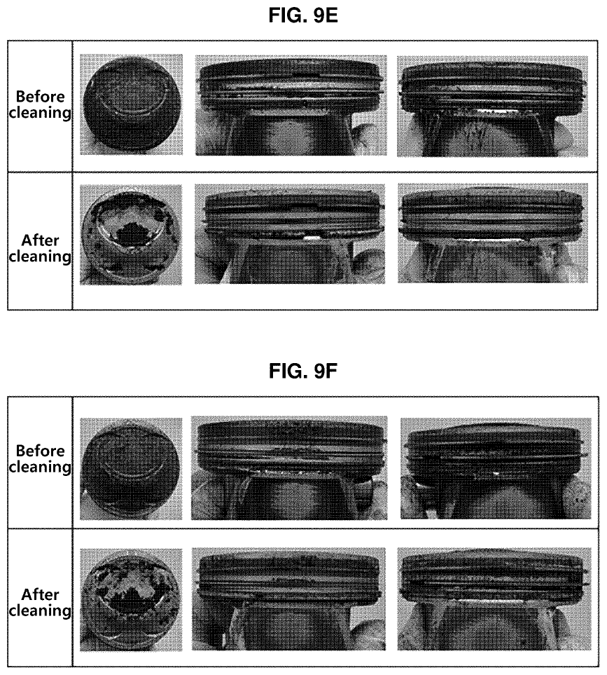

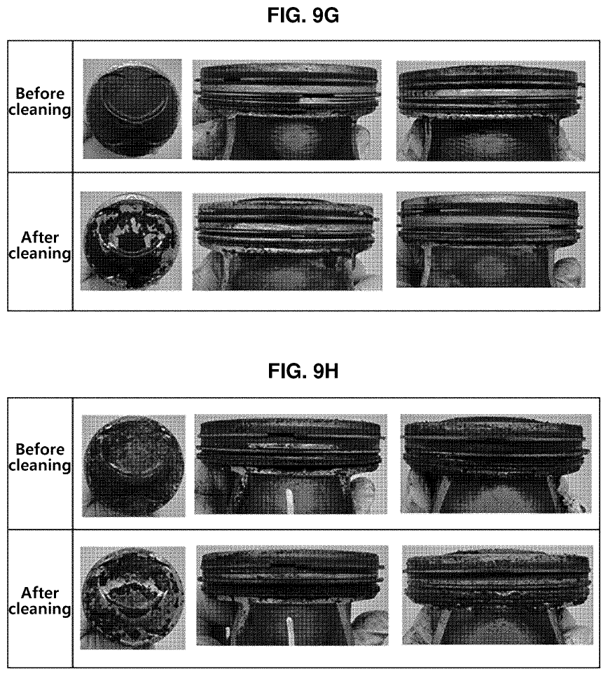

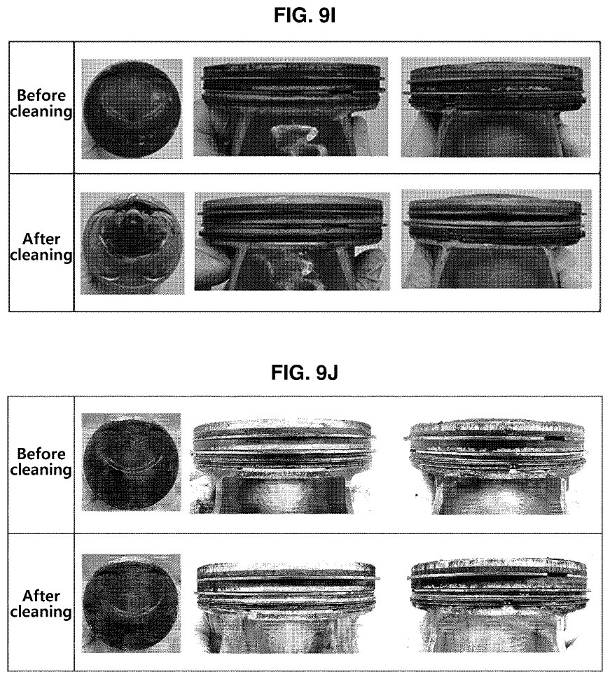

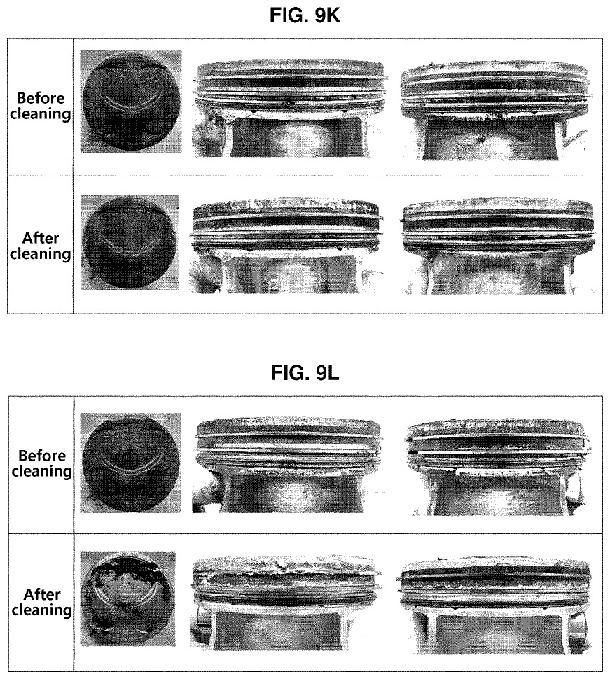

The carbon removal rate of the piston head of the mixture including water, EDTA, sodium metasilicate, and surfactant was confirmed through each of the examples composed of Table 4 and each of the comparative examples composed of Table 5, and the pH of the cleaning solution was measured, and the results are shown in Table 10 below, and pictures before and after cleaning are shown in FIGS. 8A-8L and 9A-9L.

TABLE 10

| | Whether the oil ring | Carbon Removal Rate | |
|---|---|---|---|
| | carbon is removed | Excluding Oil ring | pH |
| Example 9 | Removed | ⊚ | 11 |
| Example 10 | Removed | ⊚ | 11 |
| Example 11 | Removed | ⊚ | 12 |
| Example 12 | Removed | ⊚ | 12 |
| Example 13 | Removed | ⊚ | 12 |
| Example 14 | Removed | ⊚ | 11 |
| Example 15 | Removed | ⊚ | 10 |
| Example 16 | Removed | ⊚ | 12 |
| Example 17 | Removed | ⊚ | 13 |
| Example 18 | Removed | ◯ | 10 |
| Example 19 | Removed | ⊚ | 11 |
| Example 20 | Removed | ⊚ | 13 |
| Comparative | Not Removed | ⊚ | 9 |
| Example 19 | | | |
| Comparative | Not Removed | Δ | 10 |
| Example 20 | | | |
| Comparative | Not Removed | Δ | 9 |
| Example 21 | | | |
| Comparative | Not Removed | ◯ | 11 |
| Example 22 | | | |
| Comparative | Not Removed | ◯ | 12 |
| Example 23 | | | |
| Comparative | Not Removed | ◯ | 10 |
| Example 24 | | | |
| Comparative | Not Removed | ◯ | 9 |
| Example 25 | | | |
| Comparative | Not Removed | ◯ | 9 |
| Example 26 | | | |
| Comparative | Not Removed | ◯ | 11 |
| Example 27 | | | |
| Comparative | Not Removed | X | 7 |
| Example 28 | | | |
| Comparative | Not Removed | X | 6 |
| Example 29 | | | |
| Comparative | Not Removed | ⊚(Corrosion generation) | 12 |
| Example 30 | | | |

As can be seen in Table 10, FIGS. 8A-8L and 9A-9L of the present invention, the examples (Examples 9 to 20) of the present invention, which are the cleaning solutions containing water as a solvent, EDTA and sodium metasilicate as an additive, and a mixture of C11-14 ethoxylated propoxylated alcohol as a surfactant in the content of the present invention, exhibited stable carbon removal rates without generation of deposits compared to the cleaning solution containing no EDTA (Comparative Example 19), or the cleaning solutions containing no EDTA and deviating from the content of the sodium metasilicate of the present invention (Comparative Examples 20 and 21), the cleaning solutions containing other additives (Comparative Examples 22 to 29), and the cleaning solution containing a surfactant deviating from the content of the present invention (Comparative Example 30), and effectively removed the oil ring carbon deposits of the side portion of the piston head. In addition, in pH, the pH of the embodiments (Examples 9 to 20) in which the oil ring carbon was removed and the cleaning solution showed an effective carbon removal rate of 80% or more was found to be 10 to 13.

When the overall carbon cleaning performance was evaluated, it was found that, basically, when water was used as the solvent and EDTA was included as an additive, the cleaning solution exhibited an effect of removing oil ring carbon (Examples 1 to 3). EDTA-4Na dihydrate and EDTA-4Na tetrahydrate showed similar results. When sodium metasilicate was additionally included as an additive together with EDTA (Examples 4 to 7), the cleaning performance was further improved. Furthermore, the cleaning solution composition comprising a four-component mixture including a surfactant (Examples 9 to 20) exhibited the highest carbon removal rate for the piston head without causing corrosion at a pH of 10 to 13, effectively removed oil ring carbon, and demonstrated excellent cleaning performance and storage stability.

### INDUSTRIAL APPLICABILITY

An object of the present invention is to provide a cleaning solution composition for an engine combustion chamber, which has excellent storage stability and effectively removes carbon deposits fixed inside a cylinder of an engine.

1. An engine combustion chamber cleaning solution composition comprising water and EDTA.

2. The engine combustion chamber cleaning solution composition of claim 1, wherein the engine combustion chamber cleaning solution composition comprises, based on the total weight of the composition, 94 to 99.5 wt % of water and 0.5 to 6 wt % of EDTA.

3. The engine combustion chamber cleaning solution composition of claim 1, wherein the engine combustion chamber cleaning solution composition comprises, based on the total weight of the composition, 72 to 96 wt % of water and 0.5 to 25 wt % of EDTA, and further comprises 0.5 to 5 wt % of sodium metasilicate.

4. The engine combustion chamber cleaning solution composition of claim 1, wherein the engine combustion chamber cleaning solution composition comprises, based on the total weight of the composition, 85 to 93 wt % of water and 2 to 10 wt % of EDTA, and further comprises 4 to 6 wt % of a surfactant.

5. The engine combustion chamber cleaning solution composition of claim 1, wherein the engine combustion chamber cleaning solution composition comprises, based on the total weight of the composition, 74 to 95 wt % of water, 0.5 to 10 wt % of EDTA, and further comprises 0.5 to 5 wt % of sodium metasilicate and 0.5 to 20 wt % of a surfactant, based on the total weight of the composition.

6. The engine combustion chamber cleaning solution composition of claim 4, wherein the surfactant comprises at least one selected from the group consisting of C11-14 ethoxylated propoxylated alcohol (Alcohols, (C=11-14)-iso-, (C=13)-rich, ethoxylated propoxylated), C12-14 ethoxylated alcohols (ethoxylated alcohols (C=12-14)), ammonium lauryl sulfate, sodium ethylhexyl sulfate, sodium xylenesulfonate, sodium laureth sulfate and polyoxyethylene sorbitan monooleate.

7. The engine combustion chamber cleaning solution composition of claim 3,
further comprises 0.5 to 5 wt % of an additional additive based on the total weight of the composition,
wherein the additional additive comprises at least one selected from the group consisting of 3-methyl-3-methoxybutanol, N,N-dimethyl-1-dodecylamine N-oxide, sodium lauryl polyoxyethylene ether sulfate, sodium phosphate tribasic dodecahydrate, C9-11 ethoxylated alcohols (Ethoxylated alcohols (C=9-11)), dimethylalkylamine N-oxide, cocamidopropyl betaine, 2-methoxypropanol, N,N-dimethyl-1-dodecanamine N-oxide, sodium dodecylbenzenesulfonate, polyoxyethylene tridecyl ether, 2-ethylhexanol EO-PO nonionic surfactant, N,N-dimethyl-9-decenamide and sodium gluconate.

8. The engine combustion chamber cleaning solution composition of claim 1, wherein the EDTA is any one selected from the group consisting of EDTA-2Na dihydrate, EDTA-2Na tetrahydrate, EDTA-4Na dihydrate, and EDTA-4Na tetrahydrate.

9. The engine combustion chamber cleaning solution composition of claim 3, wherein the sodium metasilicate is any one selected from the group consisting of sodium metasilicate anhydrous, sodium metasilicate pentahydrate, and sodium metasilicate nonahydrate.

10. A method for cleaning an engine combustion chamber, comprising:
a step of preparing an engine combustion chamber cleaning solution including, based on the total weight of the composition, 74 to 95 wt % of water, 0.5 to 10 wt % of EDTA-4Na, 0.5 to 5 wt % of sodium metasilicate pentahydrate, and 0.5 to 20 wt % of C11-14 ethoxylated propoxylated alcohol (Alcohols, (C=11-14)-iso-, (C=13)-rich, ethoxylated propoxylated) as a surfactant;
an engine combustion chamber cleaning solution injection step of injecting the cleaning solution into the cylinder of the engine through a spark plug mounting hole located at a portion from which at least one spark plug installed in the engine has been removed, without disassembling the automobile engine; and
a cleaning step in which the cylinder of the engine is immersed in the cleaning solution for a predetermined time so that the cleaning solution performs cleaning, thereby removing carbon deposits adhered to an upper portion of a piston and to a side oil ring inside the cylinder of the engine.

11. The method of claim 10, wherein, in the cleaning step, the cylinder of the engine is cleaned by the engine combustion chamber cleaning solution while the cylinder is immersed in the cleaning liquid at room temperature for 2 to 18 hours.

12. The method of claim 10, wherein the engine combustion chamber cleaning solution is used in an amount of 50 to 550 mL.

13. The method of claim 10, wherein the EDTA-4Na is EDTA-4Na dihydrate or EDTA-4Na tetrahydrate.
